(19) United States
(12) Patent Application Publication
(10) Pub. No.: US 2015/0100577 A1
(43) Pub. Date: Apr. 9, 2015

(54) IMAGE PROCESSING APPARATUS AND METHOD, AND NON-TRANSITORY COMPUTER READABLE MEDIUM

(71) Applicant: FUJI XEROX CO., LTD., Tokyo (JP)

(72) Inventors: Hiroshi HAGIWARA, Kanagawa (JP); Shunichi KIMURA, Kanagawa (JP); Takahiro OKAYASU, Kanagawa (JP); Masamune OSHITANI, Kanagawa (JP)

(73) Assignee: FUJI XEROX CO., LTD., Tokyo (JP)

(21) Appl. No.: 14/268,519

(22) Filed: May 2, 2014

(30) Foreign Application Priority Data
Oct. 3, 2013 (JP) 2013-208521

(51) Int. Cl. G06F 17/30

(52) U.S. Cl. CPC G06F 17/30598; G06F 17/301
USPC 707/737

(57) ABSTRACT

An image processing apparatus includes the following elements. A memory stores therein plural items of image information. A selector selects a specific item of image information from among the plural items of image information as a selected item of image information. A specifying unit specifies, from among the plural items of image information, an item of image information indicating an image which has been captured on an identical date as a date on which an image indicated by the selected item of image information has been captured. A subject extracting unit extracts information concerning a subject of an item of image information. A destination setting unit sets a sending destination corresponding to information concerning a subject of an item of image information extracted by the subject extracting unit as a destination of the item of image information specified by the specifying unit.

### CROSS-REFERENCE TO RELATED APPLICATIONS

This application is based on and claims priority under 35 USC 119 from Japanese Patent Application No. 2013-208521 filed Oct. 3, 2013.

### BACKGROUND

### Technical Field

The present invention relates to an image processing apparatus and method, and a non-transitory computer readable medium.

### SUMMARY

According to an aspect of the invention, there is provided an image processing apparatus includes the following elements. A memory stores therein plural items of image information. A selector selects a specific item of image information from among the plural items of image information as a selected item of image information. A specifying unit specifies, from among the plural items of image information, an item of image information indicating an image which has been captured on an identical date as a date on which an image indicated by the selected item of image information has been captured. A subject extracting unit extracts information concerning a subject of an item of image information. A destination setting unit sets a sending destination corresponding to information concerning a subject of an item of image information extracted by the subject extracting unit as a destination of the item of image information specified by the specifying unit.

### BRIEF DESCRIPTION OF THE DRAWINGS

Exemplary embodiments of the present invention will be described in detail based on the following figures, wherein:

FIG. 1 is a block diagram illustrating an example of the hardware configuration of an image processing apparatus;

FIG. 2 is a block diagram illustrating an example of the functional configuration of the image processing apparatus;

FIG. 3 is a table illustrating an example of accompanying information;

FIG. 4 illustrates an example of a destination information table;

FIG. 5 is a block diagram illustrating an example of the functional configuration of a photo group specifying unit of the image processing apparatus;

FIG. 6 is a block diagram illustrating an example of the functional configuration of a continuous-period photo group specifying section of the image processing apparatus;

FIG. 7 is a flowchart illustrating processing performed by a processor according to an exemplary embodiment;

FIG. 8 is a flowchart illustrating processing performed by a photo group specifying unit and an email forming-and-sending unit according to a first exemplary embodiment;

FIGS. 9 and 10 illustrate examples of all items of image data stored in an image data storage unit;

FIG. 11 is a flowchart illustrating processing performed by the photo group specifying unit and the email forming-and-sending unit according to a second exemplary embodiment;

FIG. 12 is a flowchart illustrating processing performed by the photo group specifying unit and the email forming-and-sending unit according to a third exemplary embodiment; and

FIG. 13 is a flowchart illustrating processing performed by the photo group specifying unit and the email forming-and-sending unit according to a fourth exemplary embodiment.

### DETAILED DESCRIPTION

Exemplary embodiments of the present invention will be described below in detail with reference to the accompanying drawings.

Generally, when sharing items of image data of photos taken during an event, such as travelling or a business trip, among plural participants in the event, a user starts email software, selecting an item of image data among plural items of image data stored in a storage device, and attaching the selected item of image data to an email. The user is also required to specify the email address of a participant in this event as a destination and then sends the email.

In this method, however, if there are many items of image data to be attached or many participants in the event, the user is required to repeat an operation for attaching an item of image data to an email or an operation for specifying an email address in as a destination the same number of times as the number of items of image data or the number of participants.

Accordingly, an image processing apparatus 1 of an exemplary embodiment of the invention specifies, from among plural items of image data, an item of image data to be sent which is related to an item of image data selected by a user, and also specifies a subject person who is likely to be a participant in an event during which these items of image data have been taken. Then, the image processing apparatus 1 attaches the selected item of image data and a specified item of image data to an email, specifies the address of a specified person as an email destination, and then sends the email.

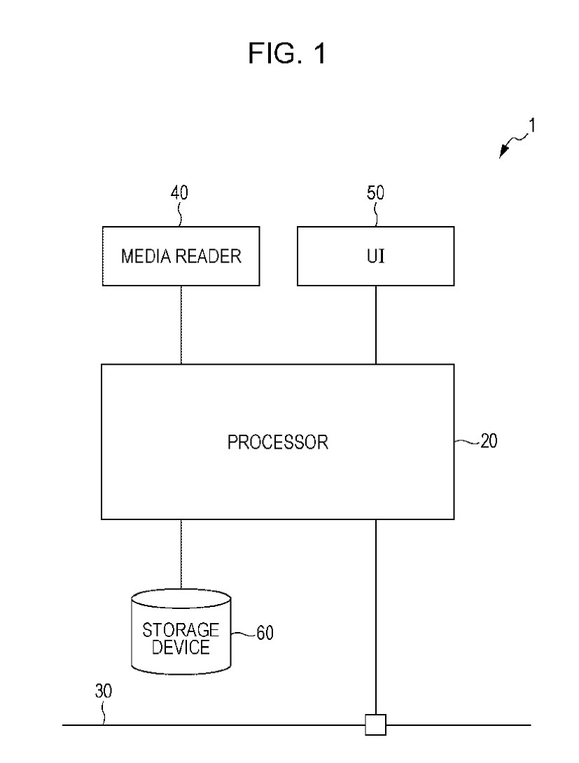

FIG. 1 is a block diagram illustrating an example of the hardware configuration of the image processing apparatus (system) 1 to which this exemplary embodiment is applied.

The image processing apparatus 1 includes, as shown in FIG. 1, a processor 20, a network 30, a media reader 40, a UI 50, which is one example of a selector, and a storage device 60.

The processor 20 is, for example, a personal computer (PC), and includes a central processing unit (CPU), a random access memory (RAM), a read only memory (ROM), and a bus which connects these elements, as shown in FIG. 1 (these elements are not shown). The network 30 is a medium for communicating with external devices in the network. The media reader 40 has a function of reading image data from a recording medium, such as a flash memory, used in a digital camera. The UI 50 is a unit through which user inputs information or the processor 20 outputs information to a user. An example of the UI 50 is a touch panel display.

The storage device 60 is, for example, a hard disk drive (HDD) or a solid state drive (SSD). The storage device 60 serves as a storage location for image data and also as a storage location for a program for controlling the processor 20 and data required for controlling the processor 20.

The image processing apparatus 1 displays a list of plural items of image data stored in the storage device 60 by using the UI 50, and instructs a user to select one item of image data from the list. Hereinafter, an item of image data selected by a user will be referred to as a “selected photo image”, and an image ID of a selected photo image will be referred to as “selected photo information”.

The image processing apparatus 1 also specifies an item of image data to be sent which is related to a selected photo image from among plural items of image data stored in the storage device 60, on the basis of a date and a location of the selected photo image, and information concerning a subject. Hereinafter, specified items of image data to be sent (including a selected photo image) will be referred to as a “sending photo image group”. In this exemplary embodiment, an image ID is used for uniquely identifying each item of image data, and a set of image IDs of a sending photo image group will be referred to as “sending image information”. The image processing apparatus 1 also specifies subject persons who are likely to be participants in a certain event, on the basis of a selected photo image and a sending photo image group. The image processing apparatus 1 then attaches the sending photo image group to an email, specifies the email address of a specified subject person as an email destination, and sends the email.

The processor 20 of a first exemplary embodiment, which will be discussed later, generates a sending photo image group (including a selected photo image) by specifying an item of image data of a photo which has been taken on the same date as that of a selected photo image and which is also likely to contain the same subject person as that of the selected photo image. The processor 20 also specifies a subject person contained in the selected photo image as a participant in an event. Then, the image processing apparatus 1 attaches the selected photo image and the sending photo image group to an email, obtains and specifies the email address of a specified person as a destination, and then sends the email.

### [Example of Functional Configuration of Image Processing Apparatus]

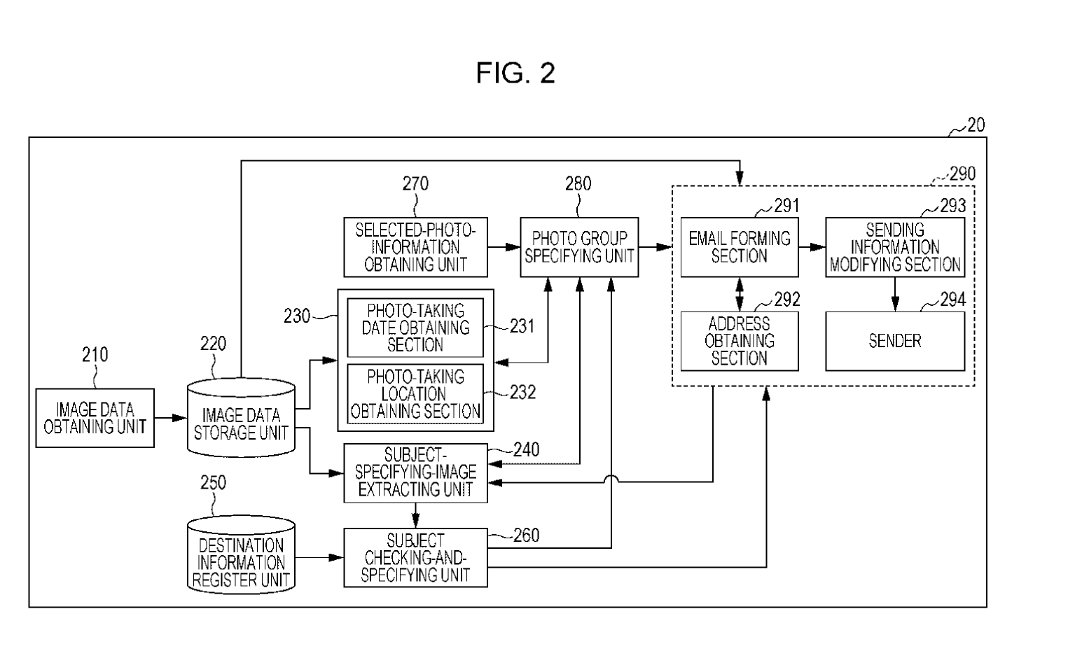

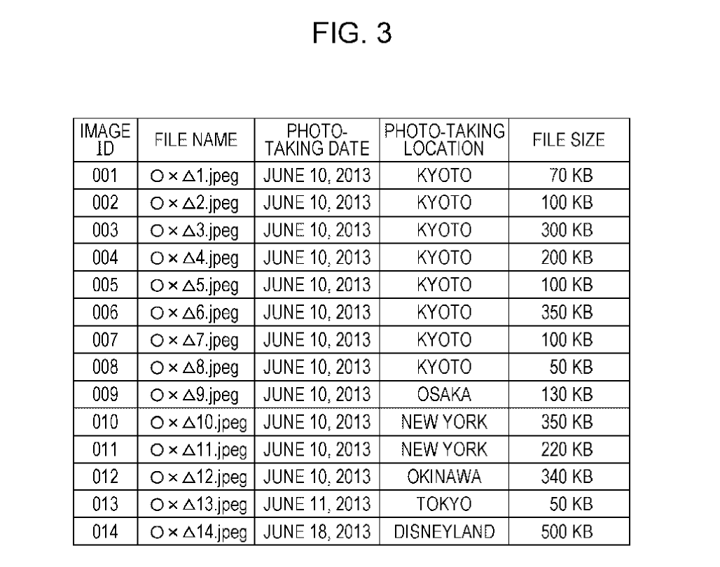

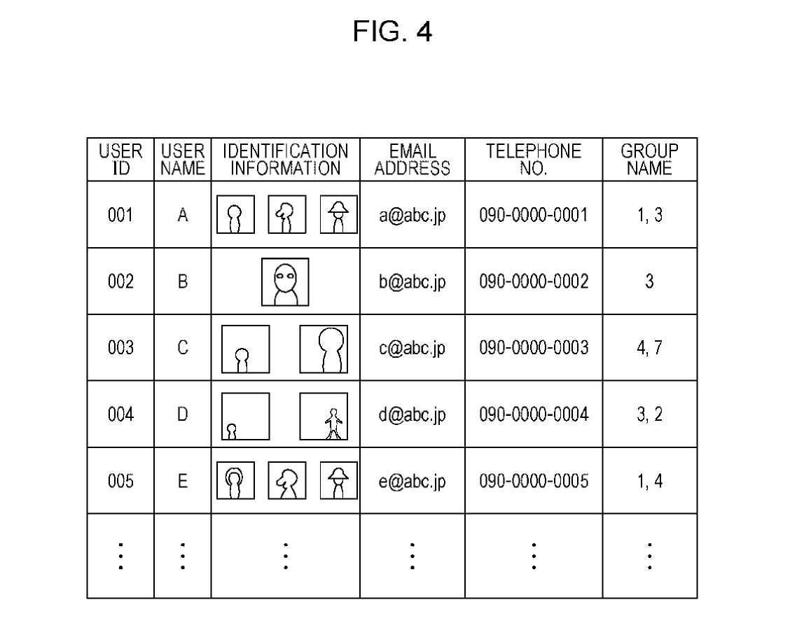

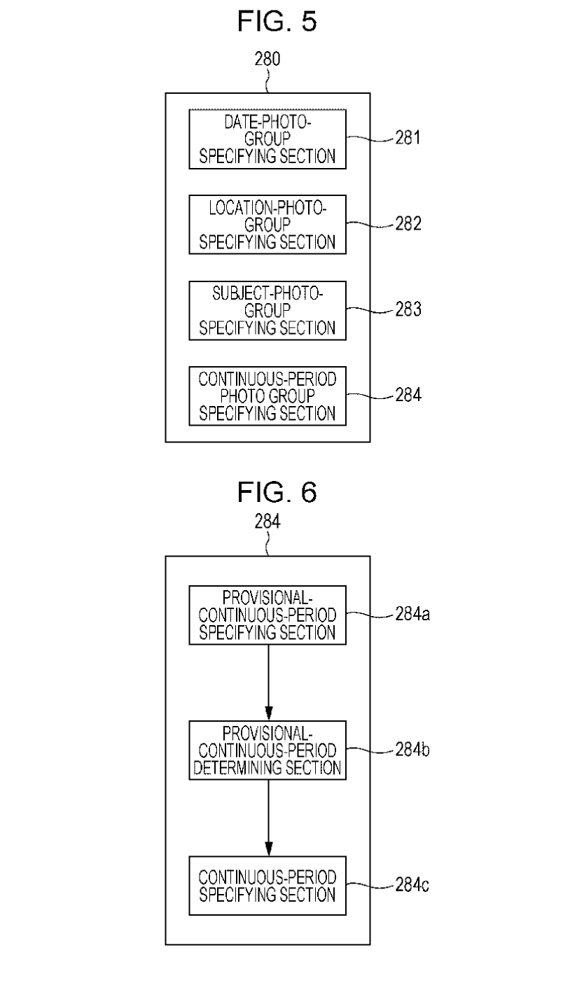

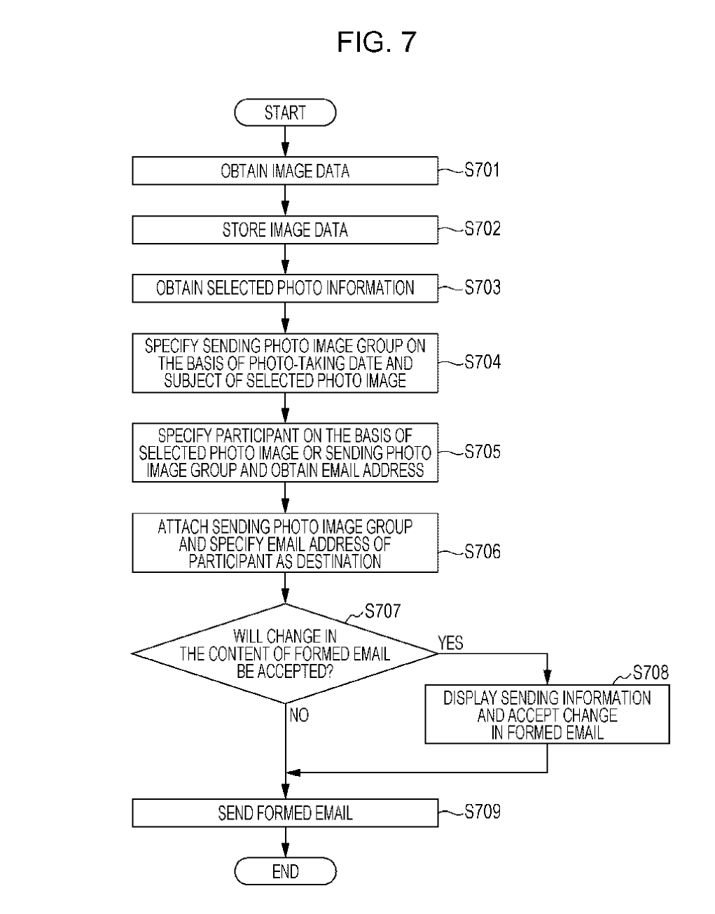

FIG. 2 is a block diagram illustrating an example of the functional configuration of the image processing apparatus 1. FIG. 3 illustrates an example of accompanying information. FIG. 4 illustrates an example of a destination information table. FIG. 5 is a block diagram illustrating an example of the functional configuration of a photo group specifying unit 280 of the image processing apparatus 1. FIG. 6 is a block diagram illustrating an example of the functional configuration of a continuous-period photo group specifying section 284 of the image processing apparatus 1.

The processor 20 includes, as shown in FIG. 2, an image data obtaining unit 210, an image data storage unit 220, an accompanying information obtaining unit 230, a subject-specifying-image extracting unit 240, a destination information register unit 250, a subject checking-and-specifying unit 260, a selected-photo-information obtaining unit 270, a photo group specifying unit 280, and an email forming-and-sending unit 290. The image data obtaining unit 210 obtains image data from an external source. The image data storage unit 220, which is an example of a memory, stores obtained image data therein. The accompanying information obtaining unit 230 obtains accompanying information which accompanies photo image data of image data stored in the image data storage unit 220. The subject-specifying-image extracting unit 240, which is an example of a subject extracting unit, extracts a subject specifying image from image data stored in the image data storage unit 220. The destination information register unit 250, which is an example of an information register unit, in which user destination information is registered. The subject checking-and-specifying unit 260 checks a subject specifying image of image data against identification information concerning users registered in the destination information register unit 250 and specifies a subject person. The selected-photo-information obtaining unit 270 obtains selected photo information input by a user through the UI 50. The photo group specifying unit 280, which is an example of a specifying unit, specifies a sending photo image group on the basis of a selected photo image. The email forming-and-sending unit 290, which is an example of a destination setting unit, forms an email by attaching a sending photo image group to the email and by specifying the email address of a specified person as a destination, and sends the formed email.

The image data obtaining unit 210 obtains image data from an external device, such as an imaging unit, via the network 30 or the media reader 40 (see FIG. 1).

The image data storage unit 220 stores therein image data obtained by the image data obtaining unit 210. The image data is constituted by photo image data generated by capturing an image by using an imaging unit and accompanying information which accompanies the photo image data. Examples of the accompanying information are, as shown in FIG. 3, an image ID, a file name, a photo-taking date, a photo-taking location, and a file size. The photo-taking location may be indicated by the latitude and the longitude measured by, for example, a global positioning system (GPS) when image data is generated, or by an area specified by the latitude and the longitude. In the example shown in FIG. 3, the photo-taking location is indicated by a general place name.

The accompanying information obtaining unit 230 obtains the above-described accompanying information from the image data storage unit 220. The accompanying information obtaining unit 230 obtains accompanying information of all items of image data stored in the image data storage unit 220, as shown in FIG. 2, such that the image IDs are associated with the other items of accompanying information. Alternatively, the accompanying information obtaining unit 230 receives the image IDs from the photo group specifying unit 280 and obtains the other items of accompanying information associated with the image IDs from the image data storage unit 220. Then, the accompanying information obtaining unit 230 supplies the other items of accompanying information associated with the image IDs to the photo group specifying unit 280.

In this case, as a method for obtaining accompanying information, the accompanying information obtaining unit 230 may extract accompanying information from an Exif file indicating information recorded with image data, such as the model type of camera and conditions for performing photo-taking, embedded in an image, or may obtain information, such as a file name, input by a user through the UI 50.

The accompanying information obtaining unit 230 includes, as shown in FIG. 2, a photo-taking date obtaining section 231 that obtains a photo-taking date of an image represented by image data, and a photo-taking location obtaining section 232 that obtains a photo-taking location of image represented by image data.

The photo-taking date obtaining section 231 obtains a photo-taking date together with an image ID from the image data storage unit 220, and supplies them to the photo group specifying unit 280. In this exemplary embodiment, the photo-taking date obtaining section 231 obtains photo-taking dates together with image IDs from accompanying information concerning all items of image data stored in the image data storage unit 220, and supplies the photo-taking date to the photo group specifying unit 280.

The photo-taking location obtaining section 232 obtains a photo-taking location associated with an image ID from the image data storage unit 220 and supplies the photo-taking location to the photo group specifying unit 280. More specifically, the photo-taking location obtaining section 232 first receives an image ID from the photo group specifying unit 280. Then, the photo-taking location obtaining section 232 obtains a photo-taking location associated with the image ID from the image data storage unit 220 and supplies the photo-taking location to the photo group specifying unit 280.

As shown in FIG. 2, the subject-specifying-image extracting unit 240 extracts, from image data stored in the image data storage unit 220, a subject specifying image, which is image data of an image region used for specifying a subject person, and supplies the extracted subject specifying image to the subject checking-and-specifying unit 260 and the photo group specifying unit 280. For example, in this exemplary embodiment, a subject specifying image is image data of an image region where the face of a certain subject person is contained. A subject person can be specified by extracting this image region.

More specifically, the subject-specifying-image extracting unit 240 receives an image ID from the photo group specifying unit 280 and extracts a subject specifying image from photo image data associated with the image ID stored in the image data storage unit 220. The subject-specifying-image extracting unit 240 then supplies the extracted subject specifying image, together with the image ID, to the subject checking-and-specifying unit 260 and the photo group specifying unit 280. If the subject-specifying-image extracting unit 240 determines that there are plural persons contained in photo image data from which a subject specifying image will be extracted, it extracts plural subject specifying images for individually specifying the plural persons.

In the destination information register unit 250, a destination information table in which user destination information is associated with identification information, which is image data used for specifying users, such as face photos, is registered. In response to a request from the subject checking-and-specifying unit 260, the destination information register unit 250 supplies information, such as an address and identification information, registered in the destination information table to the subject checking-and-specifying unit 260.

More specifically, in the destination information table, as shown in FIG. 4, items of information, such as a user ID, a user name, identification information, an email address, a telephone number, and a group name, are included. As the identification information, for enhancing the precision in specifying a person, plural items of image data may be used.

The subject checking-and-specifying unit 260 checks a subject specifying image of image data against identification information registered in the destination information register unit 250, as shown in FIG. 2, so as to specify a subject person contained in a photo represented by image data. The subject checking-and-specifying unit 260 supplies information concerning a specified person to the email forming-and-sending unit 290 and the photo group specifying unit 280. More specifically, the subject checking-and-specifying unit 260 receives an image ID and a subject specifying image from the subject-specifying-image extracting unit 240. The subject checking-and-specifying unit 260 then checks the received subject specifying image against identification information registered in the destination information register unit 250 so as to specify a subject person. The subject checking-and-specifying unit 260 also obtains other items of information stored in the destination information table, together with the name of the specified person, from the destination information register unit 250. Then, the subject checking-and-specifying unit 260 supplies the identification information and address of the specified person, together with the name of the specified person, to the email forming-and-sending unit 290 and the photo group specifying unit 280.

If the subject checking-and-specifying unit 260 is unable to specify a subject person of image data since this person is not registered in the destination information register unit 250, it sends an error message to the email forming-and-sending unit 290 and the photo group specifying unit 280. Information concerning a specified person in the destination information table is not restricted to the name of the specified person, and may be another item of information, for example, a user ID, as long as the specified person can be uniquely identified from this item of information.

When a photo image is selected by a user through the UI 50, the selected-photo-information obtaining unit 270 obtains selected photo information. The selected-photo-information obtaining unit 270 then supplies the obtained selected photo information to the photo group specifying unit 280.

The photo group specifying unit 280 includes, as shown in FIG. 5, a date-photo-group specifying section 281, a location-photo-group specifying section 282, a subject-photo-group specifying section 283, and a continuous-period photo group specifying section 284. The date-photo-group specifying section 281 specifies a set of items of image data of photos taken on the same date as that of a selected photo image (hereinafter such a set of items of image data will also be referred to as a “date photo group”). The location-photo-group specifying section 282 specifies a set of image data of photos taken in the same location or an adjacent location as or to that of a selected photo image (hereinafter such a set of items of image data will also be referred to as a “location photo group”). The subject-photo-group specifying section 283 specifies a set of items of image data indicating photos which may contain the same person as that of a selected photo image (hereinafter such a set of items of image data will also be referred to as a “subject photo group”). The continuous-period photo group specifying section 284 specifies a set of items of image data of photos taken during a continuous period including the photo-taking date of a selected photo image (hereinafter such a set of items of image data will also be referred to as a “continuous-period photo group”). The photo group specifying unit 280 then specifies, on the basis of information, such as a photo-taking date and a subject of the selected photo image, extracted from the received selected photo information, a sending photo image group from plural items of image data stored in the image data storage unit 220. The photo group specifying unit 280 then supplies the image IDs of the sending photo image group and the selected photo information to the email forming-and-sending unit 290.

The date-photo-group specifying section 281 specifies, as a date photo group, a set of items of image data of photos taken on the same date as that of a selected photo image. More specifically, the date-photo-group specifying section 281 receives, together with image IDs, information concerning photo-taking dates of all items of image data including a selected photo image stored in the image data storage unit 220 from the photo-taking date obtaining section 231. The date-photo-group specifying section 281 then compares a photo-taking date corresponding to the selected photo information with photo-taking dates corresponding to the image IDs of other items of image data, and specifies, as a date photo group (including a selected photo image), items of image data of photos taken on the same date as that of the selected photo image.

The location-photo-group specifying section 282 specifies, as a location photo group, a set of items of image data of photos taken in the same location or an adjacent location as or to that of a selected photo image. More specifically, the location-photo-group specifying section 282 supplies selected photo information and image IDs of items of image data other than the selected photo image to the photo-taking location obtaining section 232, and receives information concerning photo-taking locations corresponding to the image IDs from the photo-taking location obtaining section 232. The location-photo-group specifying section 282 then compares a photo-taking location corresponding to the selected photo information with photo-taking locations corresponding to the image IDs of the other items of image data, and specifies, as a location photo group (including a selected photo image), items of image data of photos taken in the same location or an adjacent location as or to that of the selected photo image.

In this case, the definition of the same location is as follows. The latitude and the longitude of a photo-taking location are within a predetermined range or an area of photo-taking locations is the same, for example, photos have been taken in the same area, such as in Kyoto. The definition of the same location or an adjacent location is as follows. Areas or regions in which photos have been taken are adjacent to each other and it is highly possible to move between such areas or regions within the same day. For example, a determination may be made as to whether photos have been taken in the same location or an adjacent location by determining whether photos have been taken within the Kansai region, such as in Kyoto, Osaka, and Hyogo.

The subject-photo-group specifying section 283 specifies, as a subject photo group, a set of items of image data of photos which may contain the same person as that of a selected photo image. More specifically, the subject-photo-group specifying section 283 supplies selected photo information and image IDs of items of image data other than the selected photo image to the subject-specifying-image extracting unit 240, and receives subject specifying images corresponding to the image IDs from the subject-specifying-image extracting unit 240. The subject-photo-group specifying section 283 then compares a subject specifying image corresponding to the selected photo information with subject specifying images corresponding to the image IDs of the other items of image data, and specifies, as a subject photo group (including the selected photo), items of image data of photos which are determined to contain the same person as that of the selected photo image.

In this case, a determination as to whether a subject specifying image contains the same person as that of the selected photo image may be made on the basis of the degree of similarity between the subject specifying image of the selected photo image and that of another item of image data by using a general image processing technique.

The continuous-period photo group specifying section 284 includes, as shown in FIG. 6, a provisional-continuous-period specifying section 284a, a provisional-continuous-period determining section 284b, and a continuous-period specifying section 284c. The provisional-continuous-period specifying section 284a specifies, as a provisional-continuous-period photo group, a set of items of image data of photos taken during a continuous period including a photo-taking date of a selected photo image, and also specifies such a continuous period as a provisional continuous period. The provisional-continuous-period determining section 284b determines whether a provisional continuous period will be specified as a continuous period. The continuous-period specifying section 284c specifies a new continuous period, depending on determination results of the provisional-continuous-period determining section 284b. The continuous-period photo group specifying section 284 excludes a date on which not even one photo of a specific person contained in the selected photo image is shown from the above-described provisional continuous period, and then specifies, as a continuous-period photo group, a set of items of image data of photos taken during this period.

The provisional-continuous-period specifying section 284a specifies, as a provisional-continuous-period photo group, a set of items of image data of photos taken during a continuous period including a photo-taking date of a selected photo image, and also specifies such a continuous period as a provisional continuous period. More specifically, the provisional-continuous-period specifying section 284a receives, together with image IDs, information concerning photo-taking dates of all items of image data including a selected photo image stored in the image data storage unit 220 from the photo-taking date obtaining section 231. Then, the provisional-continuous-period specifying section 284a specifies, as a provisional-continuous-period photo group (including the selected photo), a set of items of image data of photos taken on a photo-taking date or during a continuous period corresponding to the selected photo information. The provisional-continuous-period specifying section 284a also specifies, as a provisional continuous period, a continuous period including the photo-taking date of the selected photo image on the basis of the photo-taking dates of the items of image data of the provisional-continuous-period photo group.

The provisional-continuous-period determining section 284b determines, on the basis of the selected photo image, whether the provisional continuous period will be specified as a continuous period. More specifically, if a subject of the selected photo image is not contained in the persons registered in the destination information register unit 250, the provisional-continuous-period determining section 284b determines that the provisional continuous period will be specified as a continuous period. If a subject of the selected photo image is contained in the persons registered in the destination information register unit 250, the provisional-continuous-period determining section 284b determines that it is necessary that the continuous-period specifying section 284c specify a new continuous period.

The provisional-continuous-period determining section 284b makes the above-described determination specifically in the following manner. The provisional-continuous-period determining section 284b supplies selected photo information to the subject-specifying-image extracting unit 240 and causes the subject-specifying-image extracting unit 240 to extract a subject specifying image. The provisional-continuous-period determining section 284b then causes the subject checking-and-specifying unit 260 to specify a subject person from the extracted subject specifying image. If the provisional-continuous-period determining section 284b receives an error message from the subject checking-and-specifying unit 260 since the person of the subject specifying image extracted from the selected photo image is not registered in the destination information register unit 250, it determines that the provisional continuous period will be specified as a continuous period. Then, the provisional-continuous-period determining section 284b specifies the provisional continuous period as the continuous period and the provisional-continuous-period photo group as a continuous-period photo group. In contrast, if the person of the subject specifying image extracted from the selected photo image is registered in the destination information register unit 250 and the subject checking-and-specifying unit 260 specifies this person, the provisional-continuous-period determining section 284b determines that it is necessary to specify a new continuous period. In this case, the provisional-continuous-period determining section 284b obtains identification information of the specified person from the subject checking-and-specifying unit 260.

If the provisional-continuous-period determining section 284b determines that it is necessary to specify a new continuous period, the continuous-period specifying section 284c specifies a new continuous period and a new continuous-period photo group on the basis of the provisional-continuous-period photo group and the selected photo image. More specifically, the continuous-period specifying section 284c supplies the image ID of each item of image data of the provisional-continuous-period photo group to the subject-specifying-image extracting unit 240, and obtains a subject specifying image associated with each image ID. The continuous-period specifying section 284c then compares, on a daily basis, the identification information of a person specified from the selected photo image with the subject specifying image corresponding to the image ID of each item of image data of the provisional-continuous-period photo group. Then, the continuous-period specifying section 284c specifies a date during the provisional continuous period on which not even one photo of the specified person is shown. The continuous-period specifying section 284c then specifies, as a new continuous period, the provisional continuous period from which the specified date is excluded. The continuous-period specifying section 284c also specifies, as a continuous-period photo group, items of image data of photos taken during the specified continuous period.

The email forming-and-sending unit 290 includes, as shown in FIG. 2, an email forming section 291, an address obtaining section 292, a sending information modifying section 293, and a sender 294. The email forming section 291 forms an email by attaching a sending photo image group to the email by using the selected photo information and the image IDs of the sending photo image group obtained from the photo group specifying unit 280 and by specifying the address of a specified person. The address obtaining section 292 obtains the address of the specified person from the subject checking-and-specifying unit 260. The sending information modifying section 293, which is an example of an accepting unit, accepts a change in the destinations of a formed email or a sending photo image group from a user. The sender 294 sends the formed email to the destination via a network.

The email forming-and-sending unit 290 attaches a sending photo image group to an email, inputs the address of a specified person, and then sends the email. In this exemplary embodiment, before sending a formed email, the email forming-and-sending unit 290 accepts a change in the content of the email, such as the addition or the deletion of image data or an address, from a user, and reflects such a change in the email.

The email forming section 291 forms an email by attaching a sending photo image group to the email and by obtaining and specifying the address of a specified person as a destination. In this exemplary embodiment, the email forming section 291 obtains the image IDs of the sending photo image group from the photo group specifying unit 280 and obtains items of image data corresponding to the image IDs of the sending photo image group from the image data storage unit 220, and attaches the obtained items of image data to the email. The email forming section 291 also supplies the selected photo information to the address obtaining section 292 and obtains an address, such as an email address, related to the user name from the address obtaining section 292, and then specifies the address as an email destination. The email forming section 291 then supplies the formed email to the sending information modifying section 293. Alternatively, the email forming section 291 may supply the formed email directly to the sender 294.

The address obtaining section 292 obtains, from the subject checking-and-specifying unit 260, the address of a specified person registered in the destination information register unit 250 among the subjects of image data. The address obtaining section 292 also obtains the image IDs from the email forming section 291 and supplies them to the subject-specifying-image extracting unit 240. The address obtaining section 292 then causes the subject-specifying-image extracting unit 240 to extract a subject specifying image from the items of photo image data corresponding to each of the image IDs and to send the extracted subject specifying image to the subject checking-and-specifying unit 260. The address obtaining section 292 causes the subject checking-and-specifying unit 260 to specify a subject person from the subject specifying image and to obtain the email address of the specified person from the destination information register unit 250. The address obtaining section 292 then receives the email address from the subject checking-and-specifying unit 260. The address obtaining section 292 then supplies the received email address to the email forming section 291.

The sending information modifying section 293 displays, in the UI 50, information concerning a sending photo image group and destinations indicated in a formed email, and accepts the deletion of a photo image from the sending photo image group or an address from the destinations or the addition of a new photo image or a new address. More specifically, the sending information modifying section 293 receives a formed email from the email forming section 291. The sending information modifying section 293 then causes the UI 50 to display a list of information for allowing a user to uniquely identify each item of image data, such as an image ID or a file name, of the sending photo image group, and an email address or a user name specified as a destination. The sending information modifying section 293 then accepts a change in the content of the formed email, such as the addition or the deletion of image data or an address, received from a user through the UI 50, reflects such a change in the email, and then supplies the email to the sender 294.

The sender 294 then obtains the email from the email forming section 291 or the sending information modifying section 293 and sends the email to the destination via a network.

### [Example of Operation Performed by Processor]

An example of the operation performed by the processor 20 will now be described below.

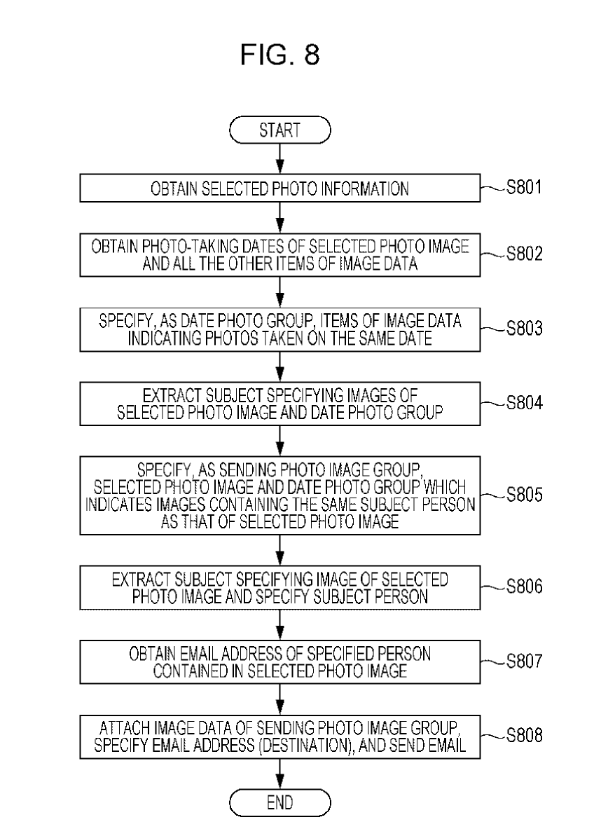

FIG. 7 is a flowchart illustrating processing performed by the processor 20 according to this exemplary embodiment.

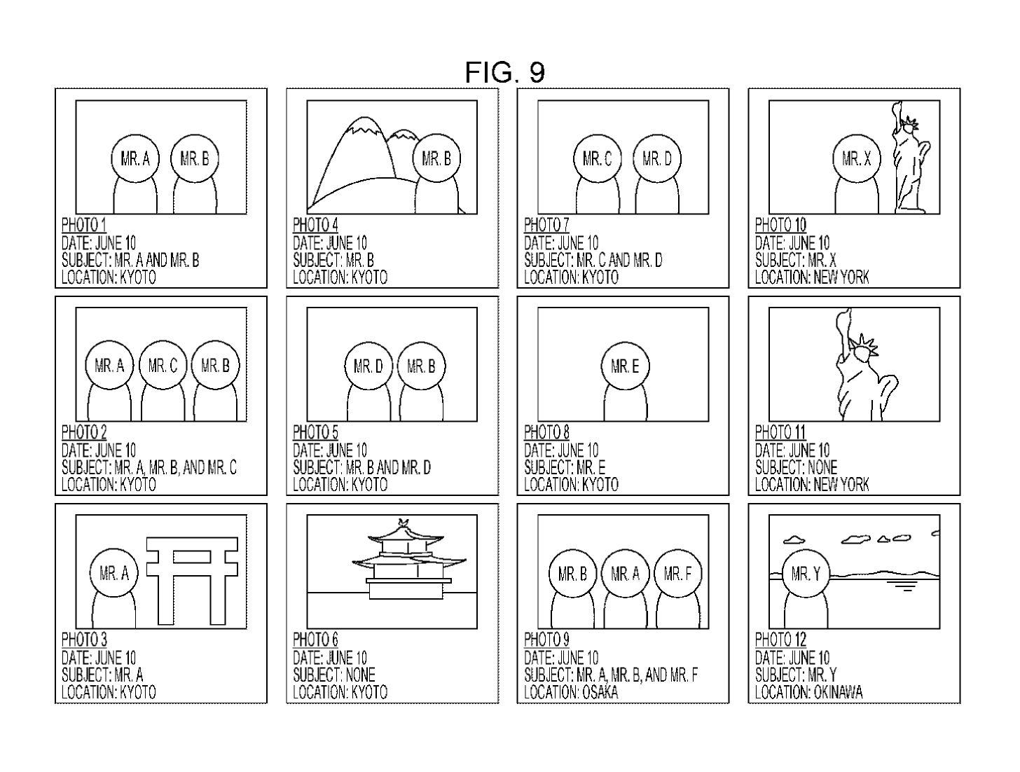

FIG. 8 is a flowchart illustrating processing performed by the photo group specifying unit 280 and the email forming-and-sending unit 290 according to a first exemplary embodiment.

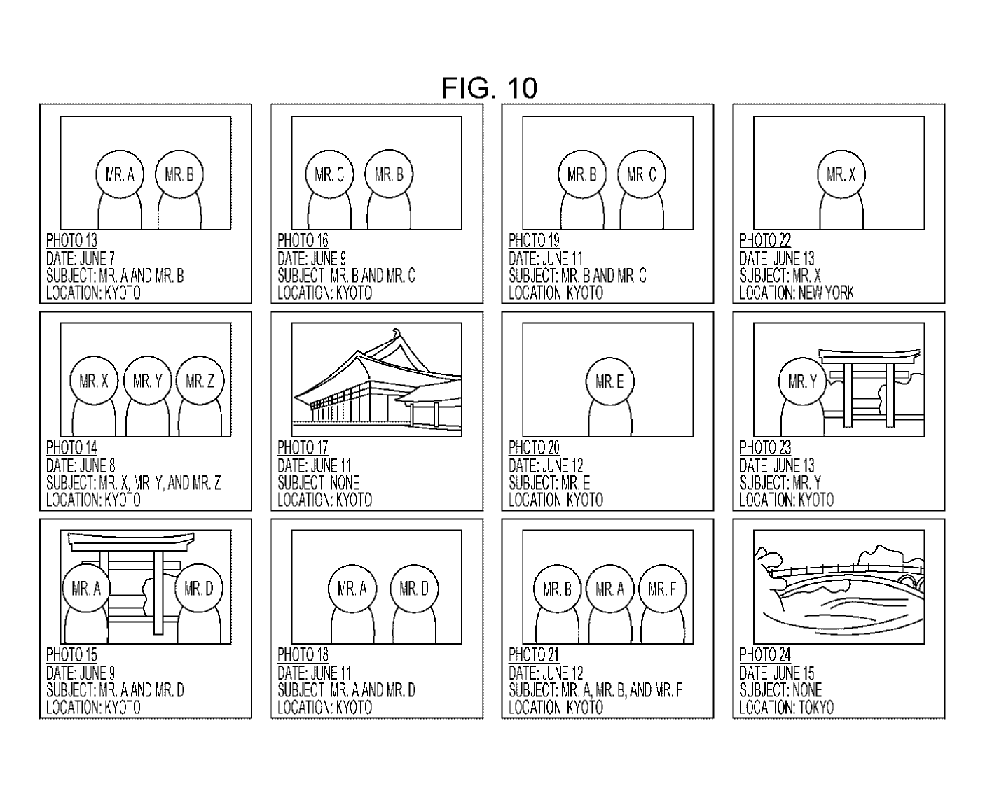

FIGS. 9 and 10 illustrate example of all items of image data stored in the image data storage unit 220.

Processing performed by the processor 20 will be specifically described below with reference to FIG. 7. In step S701, upon detecting that a recording medium is inserted into the media reader 40, the image data obtaining unit 210 obtains image data to be stored in the storage device 60 from the recording medium. Then, in step S702, the image data storage unit 220 stores the obtained image data. Then, in step S703, the selected-photo-information obtaining unit 270 obtains selected photo information concerning a photo image selected by a user. In this case, the user selects a photo image by tapping a screen for displaying a list of items of image data, such as a camera roll, stored in the image data storage unit 220.

Then, in step S704, upon receiving the selected photo information from the selected-photo-information obtaining unit 270, the photo group specifying unit 280 specifies a sending photo image group on the basis of a photo-taking date and a subject corresponding to the selected photo information by performing processing discussed later.

In step S705, the email forming-and-sending unit 290 receives the selected photo information and image IDs of the sending photo image group from the photo group specifying unit 280. The email forming section 291 supplies the selected photo information or the image IDs of the sending photo image group to the address obtaining section 292, and obtains the email address of a specified subject person from the address obtaining section 292 by performing processing discussed later. Then, in step S706, the email forming section 291 obtains items of image data of the sending photo image group from the image data storage unit 220 on the basis of the image IDs of the sending photo image group, attaches the items of image data to an email, and specifies the email address of a participant as a destination.

The sending information modifying section 293 receives the formed email from the email forming section 291. Then, it is determined in step S707 whether a change in the content of a formed email will be accepted. If the result of step S707 is YES, the process proceeds to step S708. In step S708, the sending information modifying section 293 causes the UI 50 to display the sending photo image group and the destinations and accepts any change in the content of the email, such as the addition or the deletion of image data or an address, from a user. Then, the sending information modifying section 293 reflects such a change in the email and supplies the email to the sender 294. If it is determined in step S707 that a change in the content of a formed email will not be accepted, the sending information modifying section 293 does not accept any change through the UI 50, and supplies the email to the sender 294.

Then, in step S709, the sender 294 sends the email to the destinations via a network.

### First Exemplary Embodiment

A specific description will now be given, with reference to FIG. 8, of processing for specifying a sending photo image group by the photo group specifying unit 280 and for specifying the destination of a specific subject person by the email forming-and-sending unit 290 according to the first exemplary embodiment.

In step S801, the photo group specifying unit 280 obtains selected photo information. Then, in step S802, the date-photo-group specifying section 281 obtains, together with image IDs, photo-taking dates of all items of image data including a selected photo image stored in the image data storage unit 220 from the photo-taking date obtaining section 231. Then, in step S803, the date-photo-group specifying section 281 specifies, as a date photo group (including the selected photo), items of image data of photos taken on the same date as that of the selected photo image. In the example shown in FIG. 9, if a photo 1 is selected as the selected photo image, the date-photo-group specifying section 281 specifies, as the date photo group, the photos 1 through 12 taken on the same date, that is, June 10.

Then, in step S804, the subject-photo-group specifying section 283 supplies the selected photo information and the image IDs of the individual items of image data of the date photo group to the subject-specifying-image extracting unit 240. The subject-photo-group specifying section 283 then causes the subject-specifying-image extracting unit 240 to extract subject specifying images of the selected photo image and the date photo group and receives the subject specifying images. Then, in step S805, the subject-photo-group specifying section 283 specifies, as a subject photo group, among the photos of the date photo group, items of image data of photos which may contain the same subject person as that of the selected photo image. In this case, if plural subjects are contained in the selected photo image, the subject-photo-group specifying section 283 specifies a subject photo group in the following manner. If a photo of a certain item of image data contains even one person which may be the same person as one of the subjects of the selected photo image, the subject-photo-group specifying section 283 includes such an item of image data in the subject photo group. Then, the photo group specifying unit 280 specifies the subject photo group and the selected photo image as a sending photo image group. That is, in the example shown in FIGS. 9 and 10, Mr. A and Mr. B are shown in the photo 1 (selected photo image). Accordingly, the photo group specifying unit 280 specifies, as a subject photo group, the photos 2 through 5 and 9 from among the photos 2 through 12 forming the date photo group. The photo group specifying unit 280 then specifies, as a sending photo image group, the selected photos 2 through 5 and 9, and the photo 1, which is the selected photo image.

In step S806, the email forming-and-sending unit 290 receives the sending photo image group and the selected photo information from the photo group specifying unit 280. The email forming section 291 then supplies the selected photo information to the address obtaining section 292 and causes the address obtaining section 292 to extract a subject specifying image of the selected photo image and to specify a subject person. Then, in step S807, the email forming section 291 obtains, from the address obtaining section 292, the email address of the specified person as a participant in a certain event. In the example shown in FIGS. 9 and 10, the email forming section 291 specifies Mr. A and Mr. B contained in the photo 1, which is the selected photo image, and obtains the email addresses of Mr. A and Mr. B. Then, in step S808, the email forming section 291 attaches the sending photo image group to an email on the basis of the image IDs of the sending photo image group and specifies the email address of a participant as an email destination. The sender 294 then sends the email.

In the first exemplary embodiment, the email forming section 291 may supply a formed email to the sending information modifying section 293, and the sending information modifying section 293 may accept any change in the content of the email, such as the deletion of a photo from the sending photo image group or an address from the email destinations or the addition of a new photo or a new address, though such a step is not shown in FIG. 8.

In this manner, in the first exemplary embodiment, as a result a user selecting one photo image, among photos taken on the same date as that of the selected photo image, photos showing at least one of subject persons appearing in the selected photo image are sent to these subject persons. This makes it possible to allow participants participated in a certain event on a certain date together and appearing in a selected photo image to easily share image data of photos showing such participants.

In the first exemplary embodiment, the sending information modifying section 293 accepts, from a user, any change in the content of a formed email, such as the addition of an address which has not yet been registered in the destination information register unit 250 or the deletion of an address to which photos do not have to be sent, thereby reflecting such a change in the formed email. Additionally, the deletion of photos which are not necessary to send, such as out-of-focus photos or blurred photos caused by camera shake, or, conversely, the addition of photos that a user wishes to send, is reflected in the formed email.

### Second Exemplary Embodiment

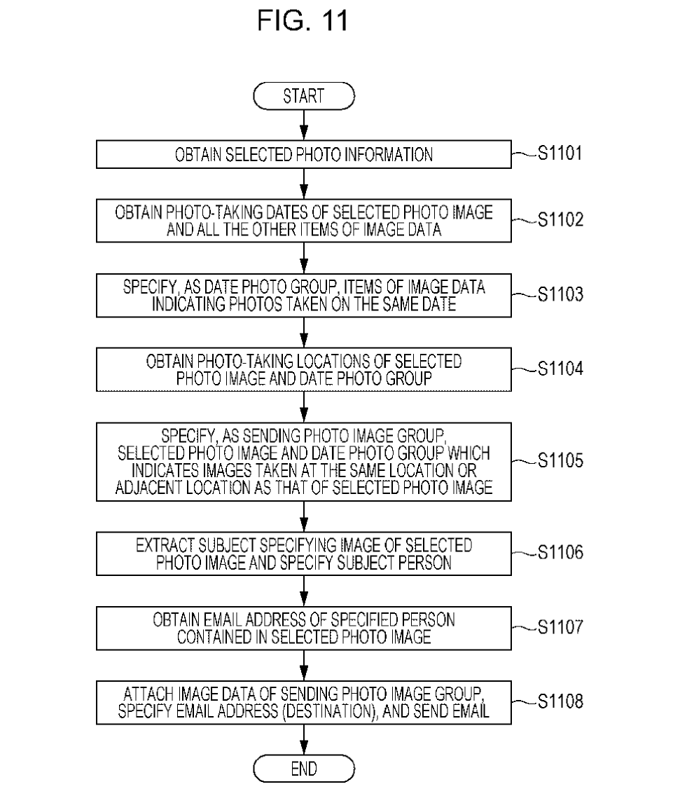

FIG. 11 is a flowchart illustrating processing performed by the photo group specifying unit 280 and the email forming-and-sending unit 290 according to a second exemplary embodiment.

In the second exemplary embodiment, the photo group specifying unit 280 specifies, as a sending photo image group, items of image data of photos taken on the same date as that of a selected photo image and taken in the same location or an adjacent location as or to that of the selected photo image. The email forming-and-sending unit 290 specifies a subject person contained in a selected photo image as a participant in a certain event. The email forming-and-sending unit 290 then attaches the sending photo image group to an email, obtains the email address of the subject person specified as a participant, specifies the email address as an email destination, and sends the email.

In step S1101, the photo group specifying unit 280 obtains selected photo information. Then, in step S1102, the date-photo-group specifying section 281 obtains, together with image IDs, photo-taking dates of all items of image data including a selected photo image stored in the image data storage unit 220 from the photo-taking date obtaining section 231. Then, in step S1103, the date-photo-group specifying section 281 specifies, as a date photo group (including the selected photo), items of image data of photos taken on the same date as that of the selected photo image.

Then, in step S1104, the location-photo-group specifying section 282 supplies the selected photo information and the image IDs of the individual items of image data of the date photo group to the photo-taking location obtaining section 232, and obtains information concerning photo-taking locations. Then, in step S1105, the location-photo-group specifying section 282 specifies, as a location photo group, among the photos of the date photo group, items of image data of photos taken in the same location or an adjacent location as or to that of the selected photo image. Then, the location-photo-group specifying section 282 specifies the location photo group and the selected photo image as a sending photo image group. In the example shown in FIGS. 9 and 10, if the photo 1 is selected as a selected photo image, the location-photo-group specifying section 282 specifies, as a location photo group, the photos 2 through 8 taken in the same location, that is, Kyoto, from among the photos 2 through 12 forming the date photo group. If Osaka is considered to be as an adjacent location of Kyoto, the location-photo-group specifying section 282 adds the photo 9 taken in Osaka and specifies the photos 2 through 9 as the location photo group. Then, the photo group specifying unit 280 specifies, as a sending photo image group, the selected photos 2 through 9, and the photo 1, which is the selected photo image.

As in the first exemplary embodiment, the email forming-and-sending unit 290 specifies a subject person in the selected photo image and obtains the email address of the specified subject person. The email forming-and-sending unit 290 then attaches a sending photo image group to an email, specifies the email address of the subject person as an email destination, and then sends the email (see steps S1106 through S1108 in FIG. 11). In the second exemplary embodiment, as well as in the first exemplary embodiment, the email forming section 291 may supply a formed email to the sending information modifying section 293, and the sending information modifying section 293 may accept any change in the content of the email, such as the deletion of a photo from the sending photo image group or an address from the email destinations or the addition of a new photo or a new address, though such a step is not shown in FIG. 11.

In this manner, in the second exemplary embodiment, items of image data of photos taken on the same date as that of a selected photo image and taken in the same location or an adjacent location as or to that of the selected photo image are sent to a subject person shown in the selected photo image. This makes it possible to allow participants participated in the same event together and appearing in a selected photo image to easily share image data of photos showing such participants. The participants are also able to share items of image data of landscape photos which do not contain any subject person in the selected photo image or photos showing another person.

### Third Exemplary Embodiment

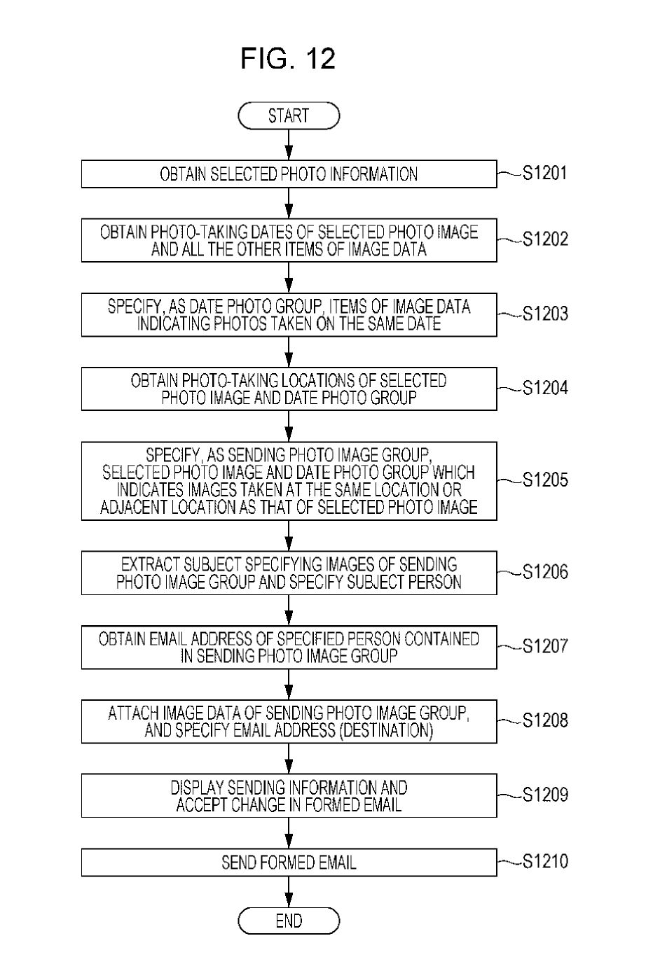

FIG. 12 is a flowchart illustrating processing performed by the photo group specifying unit 280 and the email forming-and-sending unit 290 according to a third exemplary embodiment.

In the third exemplary embodiment, the photo group specifying unit 280 specifies a sending photo image group, as in the second exemplary embodiment. The email forming-and-sending unit 290 specifies a subject person contained in a photo represented by each item of image data of a sending photo image group as a participant in a certain event. The email forming-and-sending unit 290 then attaches the sending photo image group to an email, obtains the email address of a subject person specified as a participant, specifies the email address as a destination, and sends the email.

In steps S1201 through S1205, the photo group specifying unit 280 specifies a sending photo image group, as in steps S1101 through S1105, respectively, of the second exemplary embodiment, and an explanation thereof will thus be omitted.

In step S1206, the email forming-and-sending unit 290 receives a sending photo image group and selected photo information from the photo group specifying unit 280. The email forming section 291 then supplies the image IDs of the sending photo image group to the address obtaining section 292 and causes the address obtaining section 292 to extract subject specifying images of the sending photo image group and to specify a subject person shown in each item of image data of the sending photo image group. Then, in step S1207, the email forming section 291 obtains the email address of a specified person as a participant in a certain event. In the example shown in FIGS. 9 and 10, the email forming section 291 specifies, as participants, Mr. A, Mr. B, Mr. C, Mr. D, Mr. E, and Mr. F from the photos 1 through 9, which are sending photo images, and obtains their email addresses. Then, in step S1208, the email forming section 291 attaches the sending photo image group to an email and specifies the email addresses of participants as the destinations. Then, in step S1209, the sending information modifying section 293 accepts any change in the content of the formed email. In step S1210, the sender 294 sends the email.

In this manner, in the third exemplary embodiment, a person who may be a participant in a certain event is specified from a sending photo image group. In this case, compared with a case in which a person is specified from a selected photo image, it is more likely that an unexpected person for a user will be included, or, conversely, that a person to whom a user wishes to send photos will not be specified since this person is not registered in the destination information register unit 250. Accordingly, in the third exemplary embodiment, the email forming section 291 supplies a formed email to the sending information modifying section 293, and the sending information modifying section 293 accepts any change in the content of the formed email. More specifically, the sending information modifying section 293 accepts, from a user through the UI 50, the addition of a new photo or a new address or the deletion of a photo from the sending photo image group or an address from the destinations.

In this manner, in the third exemplary embodiment, image data of a sending photo image group is sent to all of specified persons shown in the photos of the sending photo image group and also registered in the destination information register unit 250. This makes it possible to allow persons who may be participants participated in a certain event and who are registered in the destination information register unit 250 to easily share image data of photos taken during this event. Additionally, among the specified persons, the deletion of the address of a person to whom the sending photo image group does not have to be sent, or the addition of a new address is accepted. With this arrangement, even if there are many persons to whom a user wishes to send photos, it is possible to easily send them to such persons by accepting any change in the addresses as destinations.

### Fourth Exemplary Embodiment

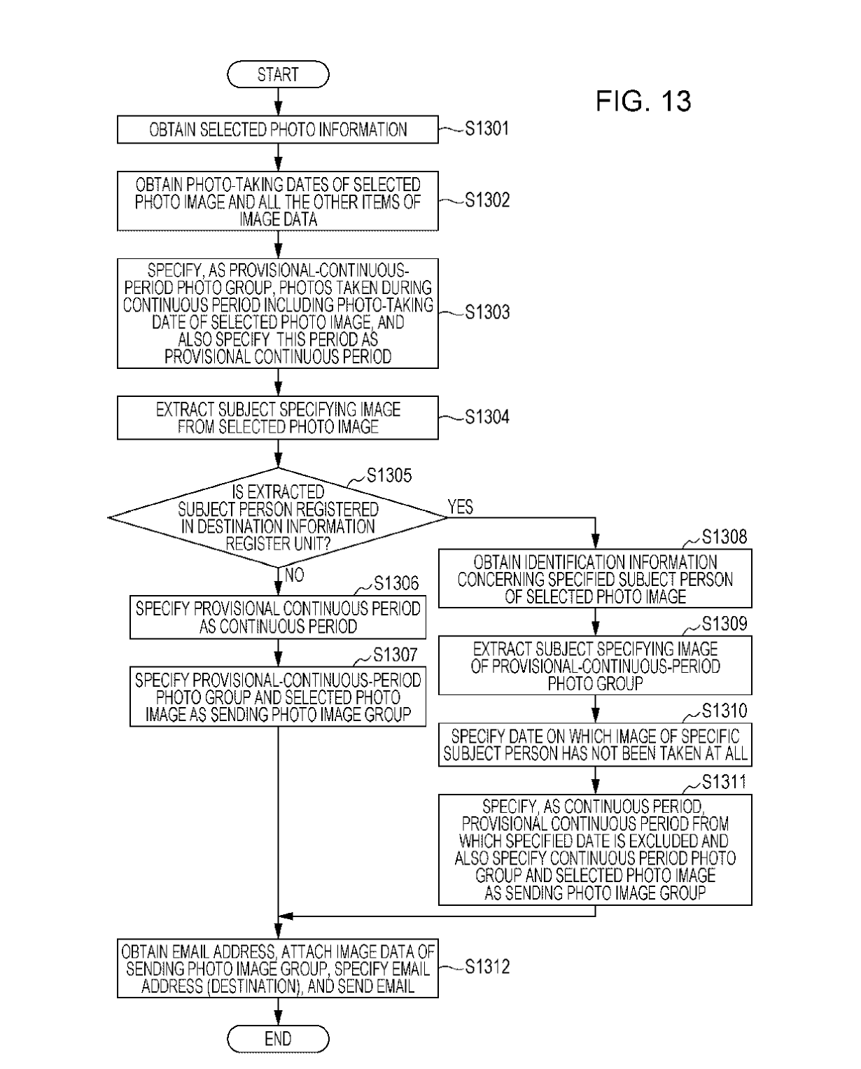

FIG. 13 is a flowchart illustrating processing performed by the photo group specifying unit 280 and the email forming-and-sending unit 290 according to a fourth exemplary embodiment.

In the fourth exemplary embodiment, the photo group specifying unit 280 specifies items of image data of photos taken during a continuous period including a photo-taking date of a selected photo image, and then specifies, as a sending photo image group, a set of items of image data of photos taken during this continuous period by excluding a date on which images of a specific person shown in a selected photo image have not been taken at all from this continuous period. The email forming-and-sending unit 290 specifies a subject person shown in the selected photo image or the sending photo image group as a participant, in a manner similar to the first through third exemplary embodiments. The email forming-and-sending unit 290 then attaches the sending photo image group to an email, specifies the email address of a participant as a destination, and sends the email.

In step S1301, the provisional-continuous-period specifying section 284a of the continuous-period photo group specifying section 284 obtains selected photo information. Then, in step S1302, the provisional-continuous-period specifying section 284a obtains, together with image IDs, photo-taking dates of all items of image data including a selected photo image stored in the image data storage unit 220 from the photo-taking date obtaining section 231. In step S1303, the provisional-continuous-period specifying section 284a also specifies, as a provisional-continuous-period photo group, items of image data of photos taken during a continuous period including the photo-taking date of the selected photo image, and also specifies this continuous period as a provisional continuous period.

In the example shown in FIGS. 9 and 10, if the photo 1 is selected as a selected photo image, the provisional-continuous-period specifying section 284a specifies, as a provisional-continuous-period photo group, the photos 1 through 12 taken on the same date as that of the selected photo image, that is, June 10. The provisional-continuous-period specifying section 284a also includes, for example, photos 13 through 23 taken during a continuous period, that is, from June 7 to June 9, and from June 11 to June 13, in the provisional-continuous-period photo group. Accordingly, the provisional-continuous-period specifying section 284a specifies the photos 2 through 23 as the provisional-continuous-period photo group and specifies a period from June 7 to June 13 as the provisional continuous period.

In step S1304, the provisional-continuous-period determining section 284b sends the selected photo information to the subject-specifying-image extracting unit 240 and causes it to extract a subject specifying image of the selected photo image. The provisional-continuous-period determining section 284b causes the subject checking-and-specifying unit 260 to check and specify the extracted subject specifying image, and determines in step S1305 whether the subject specifying image has been successfully specified. If the provisional-continuous-period determining section 284b receives an error message from the subject checking-and-specifying unit 260 since the subject person of the extracted subject specifying image is not registered in the destination information register unit 250, it means that the result of step S1305 is NO. Then, the process proceeds to step S1306. In step S1306, the provisional-continuous-period determining section 284b specifies the provisional continuous period as a continuous period. Then, in step S1307, the provisional-continuous-period determining section 284b specifies the provisional-continuous-period photo group as a continuous-period photo group, and specifies the selected photo image and the continuous-period photo group as a sending photo image group.

If it is determined in step S1305 that the subject specifying image has been successfully specified, the process proceeds to step S1308. In step S1308, the provisional-continuous-period determining section 284b receives identification information concerning the specified subject person from the subject checking-and-specifying unit 260. Then, in step S1309, the continuous-period specifying section 284c supplies the image IDs of the provisional-continuous-period photo group to the subject-specifying-image extracting unit 240, and obtains subject specifying images of the provisional-continuous-period photo group. Then, in step S1310, the continuous-period specifying section 284c compares, on a daily basis, the identification information concerning the specified subject with the subject specifying images of the provisional-continuous-period photo group. The continuous-period specifying section 284c then specifies a date on which not even one photo of the specified subject is shown. Then, in step S1311, the continuous-period specifying section 284c specifies, as a continuous period, the provisional continuous period from which the specified date is excluded. The continuous-period specifying section 284c also specifies items of image data of photos taken during the continuous period as a continuous-period photo group and specifies the continuous-period photo group and the selected photo image as a sending photo image group. In step S1312, as in the first through third exemplary embodiments, the email forming-and-sending unit 290 obtains the email address of a specified subject person, attaches the sending photo images to an email, specifies the obtained email address as a destination, and then sends the email.

This will be described more specifically by taking the example shown in FIGS. 9 and 10. The continuous-period determining section 284b determines June 8 (photo 14) and June 13 (photos 22 and 23) on which images of Mr. A and Mr. B contained in the selected photo image are not shown at all. Then, the continuous-period specifying section 284c specifies, as a continuous period, June 7 and June 9 through 12, from which June 8 and June 13 are excluded from June 7 through 13, which is the provisional continuous period. The continuous-period specifying section 284c also specifies the photos 1 through 13 and 15 through 21 as a continuous-period photo group.

In this manner, in the fourth exemplary embodiment, image data of photos concerning an event taken place during a predetermined period, such as travelling or a long business trip, can be easily shared among specified persons.

In the fourth exemplary embodiment, in the example shown in FIGS. 9 and 10, photos specified as a continuous-period photo group include a photo concerning an event other than the event taken place in Kyoto where the selected photo image has been taken, such as the photo 11 taken in New York. Accordingly, as in the third exemplary embodiment, the sending information modifying section 293 may accept, from a user, any change in the content of an email, such as the deletion of a photo from a sending photo image group or an address from destinations, or an addition of a new photo or a new address.

As described above, in the first through fourth exemplary embodiments, the photo group specifying unit 280 specifies a sending photo image group on the basis of a date of a selected photo image, a location, a subject person, or a continuous period. Then, a subject person specified on the basis of the selected photo image or the sending photo image group is specified as a participant in a certain event. Then, an email is formed by attaching the sending photo image group and by specifying the email address of the specified subject person as a destination, and then, the email is sent.

Alternatively, persons belonging to a certain group registered in the destination information may be specified as destinations, and image data of photos may be sent to such persons. In this case, the address obtaining section 292 refers to a group name of a specified person shown in a sending photo image group or a selected photo image, and obtains the email addresses of persons belonging to this group. This makes it possible to allow the specified person to share image data of the specified sending photo image group with his/her friends or family.

In the fourth exemplary embodiment, the continuous-period photo group specifying section 284 specifies a continuous period by using a selected photo image and a provisional-continuous-period photo group. Alternatively, a continuous period may be specified on the basis of data concerning, for example, an itinerary, obtained from an external device connected to the image processing apparatus via a communication medium. In this case, image data of a photo taken during an event, such as travelling or a business trip, on a date on which a photo of a specified person is not shown at all is also included in a sending photo image group.

Additionally, the photo group specifying unit 280 may utilize identification information concerning a certain person, and may specify all items of image data of photos showing this person from among the items of image data stored in the image data storage unit 220. With this arrangement, it is possible to create an album of items of image data of photos showing a certain person, and this album may be easily shared with another person.

The photo group specifying unit 280 may specify a sending photo image group in a manner different from the patterns employed in the first through fourth exemplary embodiments. For example, a sending photo image group may be specified by a combination of patterns using the date-photo-group specifying section 281, the location-photo-group specifying section 282, the subject-photo-group specifying section 283, and the continuous-period photo group specifying section 284. A list of patterns for specifying a sending photo image group may be displayed in the UI 50, and then, upon receiving a selected pattern from a user, information concerning the selected pattern may be obtained together with selected photo information. In this case, in addition to the selection of a pattern for specifying a sending photo image group, an instruction concerning a setting whether to accept a change in the content of a formed email by using the sending information modifying section 293 may also be received.

Then, the subject-photo-group specifying section 283 is not used, as in the second exemplary embodiment, and an instruction to specify a sending photo image group from landscape photos (which do not show persons registered at all) is accepted. Additionally, an instruction to delete identification information or a group name of a certain person from the destination information register unit 250 may be accepted through the UI 50, and this person may be excluded from email destinations.

Alternatively, an instruction to specify items of image data of photos only showing a certain person by using the subject-photo-group specifying section 283 and to exclude such items of image data from a sending photo image group may be accepted. Conversely, an instruction to send items of image data of photos only showing a certain person to this person as a sending photo image group may be accepted. In this case, for example, among the photos 1 through 8 shown in FIG. 9, the photos 1 through 3 are sent to Mr. A, the photos 1, 2, 4, and 5 are sent to Mr. B, the photos 2 and 7 are sent to Mr. C, the photos 5 and 7 are sent to Mr. D, and the photo 8 is sent to Mr. E. In addition to a photo showing a certain person, a landscape photo without including this person may also be sent to this person. For example, the photo 6, as well as the photos 1 through 3, may be sent to Mr. A.

In the first through fourth exemplary embodiments, the image ID is used as information for uniquely identifying image data. However, another item of information, such as a file name or a storage location, may be used. Accompanying information obtained by the accompanying information obtaining unit 230 is not restricted to a photo-taking date or a photo-taking location. Instead, the accompanying information obtaining unit 230 may obtain a file size and a file name of image data, and a sending photo image group may be specified by using these items of accompanying information. Additionally, selected photo information may be input from a user through an input unit, such as a touch panel of an imaging unit, instead of by using the UI 50 of the image processing apparatus 1.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
a memory that stores therein a plurality of items of image information;
a selector that selects a specific item of image information from among the plurality of items of image information as a selected item of image information;
a specifying unit that specifies, from among the plurality of items of image information, an item of image information indicating an image which has been captured on an identical date as a date on which an image indicated by the selected item of image information has been captured;
a subject extracting unit that extracts information concerning a subject of an item of image information; and
a destination setting unit that sets a sending destination corresponding to information concerning a subject of an item of image information extracted by the subject extracting unit as a destination of the item of image information specified by the specifying unit.

2. The image processing apparatus according to claim 1, wherein:
the subject extracting unit extracts information concerning a subject of the selected item of image information; and
the destination setting unit sets a sending destination corresponding to the information concerning the subject of the selected item of image information as a destination of the item of image information specified by the specifying unit.

3. The image processing apparatus according to claim 1, wherein:
the subject extracting unit extracts information concerning a subject of the item of image information specified by the specifying unit; and
the destination setting unit sets a sending destination corresponding to the information concerning the subject of the specified item of image information as a destination of the specified item of image information.

4. The image processing apparatus according to claim 1, further comprising:
an information register unit that registers therein information concerning a group to which a subject belongs,
wherein the destination setting unit sets a sending destination corresponding to information concerning a group to which a subject of the selected item of information belongs as a destination of the item of image information specified by the specifying unit.

5. The image processing apparatus according to claim 1, wherein:
the subject extracting unit extracts information concerning a subject of the item of image information specified by the specifying unit and a subject of the selected item of image information; and
the specifying unit specifies an item of image information from among the specified item of image information and the selected item of image information, on the basis of the information concerning the subject of the specified item of image information and the subject of the selected item of image information.

6. The image processing apparatus according to claim 1, further comprising:
an accepting unit that accepts the deletion of an item of image information specified by the specifying unit or the addition of another item of image information or the deletion of a sending destination set by the destination setting unit or the addition of another sending destination.

7. An image processing apparatus comprising:
a memory that stores therein a plurality of items of image information;
a selector that selects a specific item of image information from among the plurality of items of image information as a selected item of image information;
a specifying unit that specifies, from among the plurality of items of image information, an item of image information indicating an image which has been captured during a predetermined capturing period including a date on which an image indicated by the selected item of image information has been captured;
a subject extracting unit that extracts information concerning a subject of an item of image information; and
a destination setting unit that sets a sending destination corresponding to information concerning a subject of an item of image information extracted by the subject extracting unit as a destination of the item of image information specified by the specifying unit.

8. The image processing apparatus according to claim 7, wherein:
the subject extracting unit extracts information concerning a subject of the selected item of image information and a subject of the item of image information specified by the specifying unit; and
the specifying unit specifies, from among the selected item of image information and the specified item of image information, a date on which an image of the subject of the selected item of image information has not been captured, and specifies an item of image information indicating an image which has been captured during a period from which the specified date is excluded from the predetermined capturing period.

9. The image processing apparatus according to claim 7, wherein the specifying unit obtains information concerning the predetermined capturing period from an external source and specifies the predetermined capturing period.

10. An image processing apparatus comprising:
a memory that stores therein a plurality of items of image information;
a selector that selects a specific item of image information from among the plurality of items of image information as a selected item of image information;
a location extracting unit that extracts location information concerning the plurality of items of image information;
a specifying unit that specifies, from among the plurality of items of image information, an item of image information indicating an image which has been captured in a location indicated by location information within a predetermined range and which has been captured on an identical date as a date on which an image indicated by the selected item of image information has been captured;
a subject extracting unit that extracts information concerning a subject of an item of image information; and
a destination setting unit that sets a sending destination corresponding to information concerning a subject of an item of image information extracted by the subject extracting unit as a destination of the item of image information specified by the specifying unit.

11. An image processing method comprising:
selecting a specific item of image information from among a plurality of items of image information as a selected item of image information;
specifying, from among the plurality of items of image information, an item of image information indicating an image which has been captured on an identical date as a date on which an image indicated by the selected item of image information has been captured;
extracting information concerning a subject of an item of image information; and
setting a sending destination corresponding to the extracted information concerning a subject of an item of image information as a destination of the specified item of image information.

12. A non-transitory computer readable medium storing a program causing a computer to execute a process, the process comprising:
selecting a specific item of image information from among a plurality of items of image information as a selected item of image information;
specifying, from among the plurality of items of image information, an item of image information indicating an image which has been captured on an identical date as a date on which an image indicated by the selected item of image information has been captured;
extracting information concerning a subject of an item of image information; and
setting a sending destination corresponding to the extracted information concerning a subject of an item of image information as a destination of the specified item of image information.
